(19) United States
(12) Patent Application Publication
(10) Pub. No.: US 2006/0155563 A1
(43) Pub. Date: Jul. 13, 2006

(54) Method, system and article for advance lease negotiation in DHCP

(76) Inventors: Dwip N. Banerjee, Austin, TX (US); Lilian Sylvia Fernandes, Austin, TX (US); Vasu Vallabhaneni, Austin, TX (US); Vinit Jain, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/034,274

(22) Filed: Jan. 12, 2005

(51) Int. Cl. G06Q 99/00

(52) U.S. Cl. 705/1

(57) ABSTRACT

DHCP lease negotiation is performed in advance of a specified time when the IP address is needed. The client sends a DHCP discover message with an advance lease option indicating a future time when an IP address is needed. The DHCP server reserves an IP address available at the requested time for the requesting client and sends a DHCP acknowledgment of the reservation. Thereafter, the client sends a DHCP discover message requesting the reserved IP address, and the DHCP server assigns it to the client at the scheduled time.

### BACKGROUND OF THE INVENTION

1. Field of the Invention

The present invention relates in general to data processing systems, and in particular to negotiation for IP addresses with Dynamic Host Control Protocol (DHCP) servers.

2. Description of the Related Art

Computers can connect to each other over networks and over the Internet using TCP/IP protocol. TCP/IP stands for Transmission Control Protocol/Internet Protocol, which is a family of networking protocols providing communication across interconnected networks, between computers with diverse hardware architectures, and between various computer operating systems.

Network communication using TCP/IP typically requires each device on the network to have a unique IP address. An IP address is a unique, 32-bit identifier for a specific TCP/IP computer on a network, such as the Internet. IP addresses are also referred to as Internet Addresses. However, IP addresses are also used for communications within networks smaller than the Internet. The IP address is a “structured” address that contains both network and device information. Current IP addresses are in dotted decimal form, such as 111.123.09.191, with each of the four address fields assigned as many as 255 values.

Dynamic Host Control Protocol (DHCP) is an open, industry standard protocol that reduces the complexity of administering networks based on TCP/IP. Each host computer connected to a TCP/IP network must be assigned a unique IP address. Prior to DHCP servers, if a network was to be attached to the Internet, the network administer would obtain a unique network ID and ensure that IP addresses on the assigned network were unique. On a large network, this was a difficult problem. DHCP provided a solution by having a DHCP server assign an IP address to a DHCP client when the client computer initialized. Therefore, DHCP allowed for the addition of a new computer to a network without bothering a network administrator to manually assign a unique IP address. DHCP is useful whether a client is connecting to the Internet or a much smaller network such as a LAN.

Like its predecessor, the Bootstrap Protocol (Bootp), DHCP supports manual, automatic and dynamic address assignment, and is routable. With dynamic addressing, a device can have a different IP address every time it connects to the network. In some systems, the device's IP address could even change while it is still connected. DHCP also supports a mix of static and dynamic IP addresses.

DHCP provides for automatic dynamic allocation of IP client configurations for a specified period of time, called a lease period. DHCP will not reclaim the IP address until the lease time has expired. It is not uncommon to have a DHCP server with an IP address pool that has a lease time of three days. The amount of time that the name/address is valid in a domain name server coincides with the lease time. When a client obtains an IP address, the client also may include a name used to reach the client. The DHCP server sends this name/address mapping to a domain name server, which will store this mapping in a set of domain name service (DNS) entries.

When a DHCP-enabled client computer boots, it broadcasts a message requesting information with which to configure its network interface so that the TCP/IP protocol stack can be used for communication. DHCP servers receive the message from the client and send replies that contain the requested configuration information. The essential pieces of information that must be supplied by the DHCP server include an IP address and a subnet mask.

Such DHCP operations typically fall into four basic phases. The first phase is the IP lease request. When a client computer is booted or comes on-line to a network, the client computer checks to see if it has an IP address leased. If it does not have an IP address leased, the client computer requests a lease from a DHCP server. Because the client computer does not know the address of the DHCP server, the client computer broadcasts a DHCP-DISCOVER packet across the network to make the request.

The second phase of DHCP operation involves the lease offer. When a DHCP server receives an IP lease request (DHCP-DISCOVER) from a client computer, the DHCP server extends an IP lease offer. IP lease offers are extended by immediately reserving an IP address for the client computer and broadcasting a DHCP-OFFER packet across the network.

The third phase of DHCP operation is for the client to inform servers that the client has accepted an IP lease offer. When the client computer receives the IP lease offer, the client computer sends a DHCP-REQUEST packet over the network to inform all the other DHCP servers that it has accepted an offer. When the other DHCP servers receive this message, the DHCP servers withdraw any offers that they might have made to the client computer and return unused addresses back to the pool of valid addresses available. Any number of DHCP servers could respond to an IP lease request, but the client computer can only accept one offer per network interface card.

The fourth phase of DHCP operation is the acknowledgment phase. When the DHCP server receives the DHCP-REQUEST packet from the client computer, the DHCP server initiates the final phase of the DHCP operation. This acknowledgement phase involves sending a DHCP-ACK packet to the client computer. This packet includes the lease duration and any other configuration information that the client might have requested. At this point, the TCP/IP configuration process is complete.

In the current DHCP specification, Request For Comments 2131 (RFC2131), the server returns a requested IP address to the DHCP client immediately, if available, for immediate use by the client. What is not currently accommodated in the DHCP specification is the ability for a client to reserve an IP address in advance of when it will be needed. For example, a user may know that he will be connecting to a network behind a firewall at a certain time in the future. It would be desireable to inform the network administrator of the need for a channel through the firewall for the user's IP address, so that certain applications can be run on the client as soon as the user makes a connection. To make such a request to the system administrator, it is required that the user know in advance what IP address the DHCP server will assign to the client. Another example is where a user knows in advance of a specific time that he will be connecting to a certain network and would like to guarantee to get an IP address for the scheduled connection. For instance, a salesman may want to present an on-line sales presentation at a scheduled appointment. Under certain conditions in networks having a large number of connected hosts, it is possible that the DHCP servers may be out of available IP addresses at the moment that the user attempts to connect to the network. It can be seen that it would be desirable to provide a mechanism to reserve a DHCP-issued IP address in advance of the user making a connection to the network to guarantee that at the time the user attempts to obtain network connectivity, an IP address is available.

### SUMMARY OF THE INVENTION

In accordance with the present invention, improved methods, systems and articles of manufacture for advance lease negotiation in DHCP are disclosed. One preferred method of the present invention comprises the steps of receiving a reservation request from a client to be assigned an IP address at a specific time in the future; reserving a specific IP address for the client to be assigned at the specific time requested; and assigning the specific IP address to the client after the specified time in response to receiving an assignment request from the client for the reserved IP address.

All objects, features, and advantages of the present invention will become apparent in the following detailed written description.

### BRIEF DESCRIPTION OF THE DRAWINGS

This invention is described in a preferred embodiment in the following description with reference to the drawings, in which like numbers represent the same or similar elements, as follows:

FIG. 1 depicts a pictorial representation of a network of data processing systems in which the present invention may be implemented.

FIG. 2 is a block diagram of a data processing system that may be implemented as a server, in accordance with a preferred embodiment of the present invention.

FIG. 3 is a block diagram illustrating a data processing system that may be implemented as a client, in accordance with a preferred embodiment of the present invention.

FIG. 4 illustrates a simple view of a client-server based DHCP IP Address negotiation.

FIG. 5 shows a DHCP message header and its associated fields, in accordance with a preferred embodiment of the present invention.

FIG. 6 shows a flow diagram of a process for advance lease negotiation in DHCP, in accordance with the preferred embodiment of the present invention.

### DETAILED DESCRIPTION OF PREFERRED EMBODIMENTS

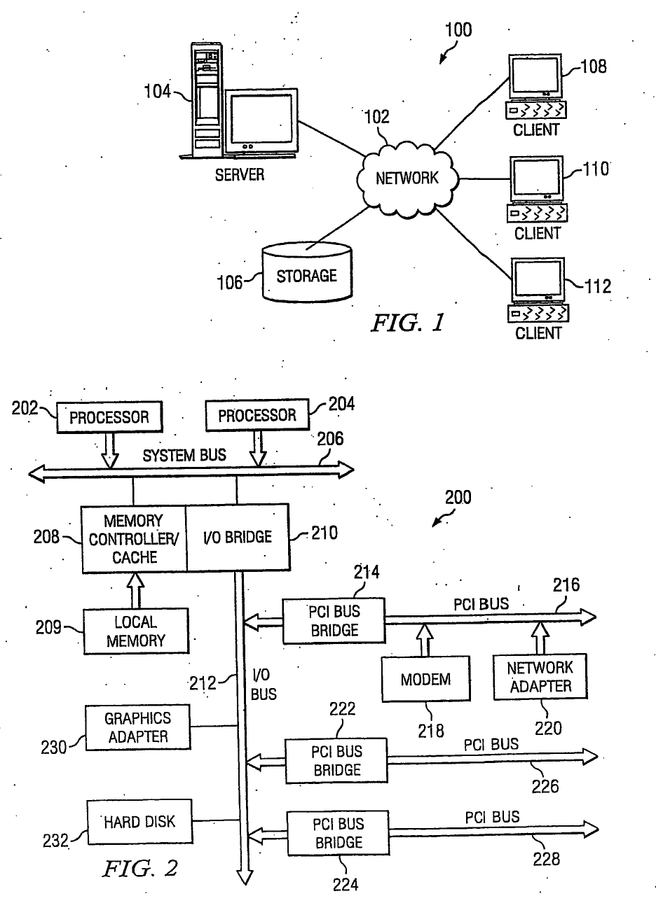

With reference now to the figures, FIG. 1 depicts a pictorial representation of a network of data processing systems in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. In the illustrative examples, server 104 may act as a DHCP server and/or a domain name system server. Network data processing system 100 may include additional servers, clients, and other devices not shown.

In the depicted example, network data processing system 100 includes the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may function as either or as both a DHCP server and a DNS server depending on the particular implementation. Dynamic Host Control Protocol (DHCP) is the industry standard protocol specified in RFC2131, available in most technical libraries and on the Internet. RFC2131 is incorporated herein by reference.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM eServer pSeries system, a product of International Business Machines Corporation in Armonk, N.Y., running the Advance Interactive Executive (AIX) operating system or LINUX operating system.

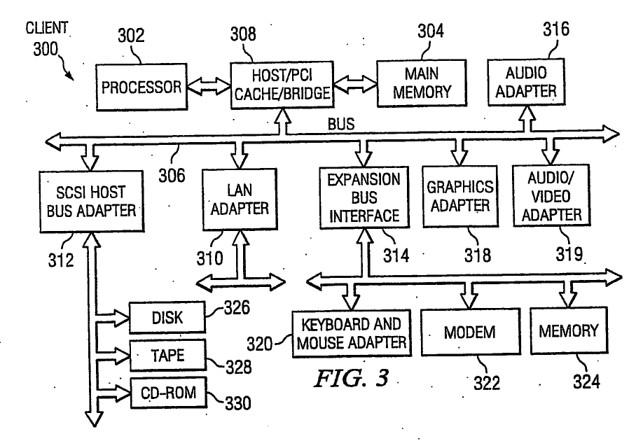

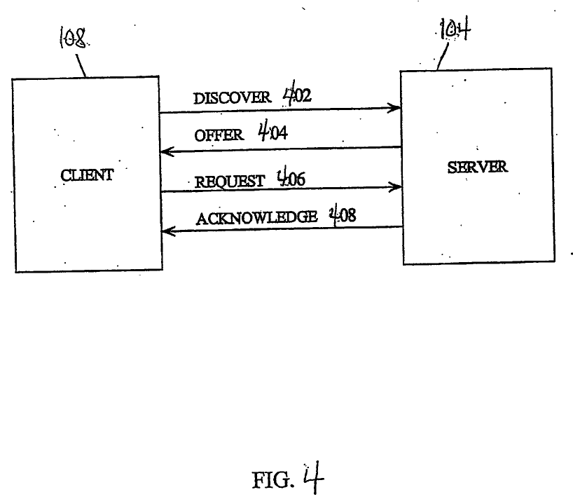

With reference now to FIG. 3, a block diagram illustrating a data processing system that may be implemented as a client, in accordance with a preferred embodiment of the present invention. Data processing system 300 is an example of a client computer. Data processing system 300 employs a peripheral component interconnect (PCI)local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302.

Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system. The depicted example in FIG. 3 and above-described examples are not meant to imply architectural limitations. For example, data processing system 300 also may be a notebook computer or hand held computer in addition to taking the form of a PDA, or may be a kiosk or a Web appliance.

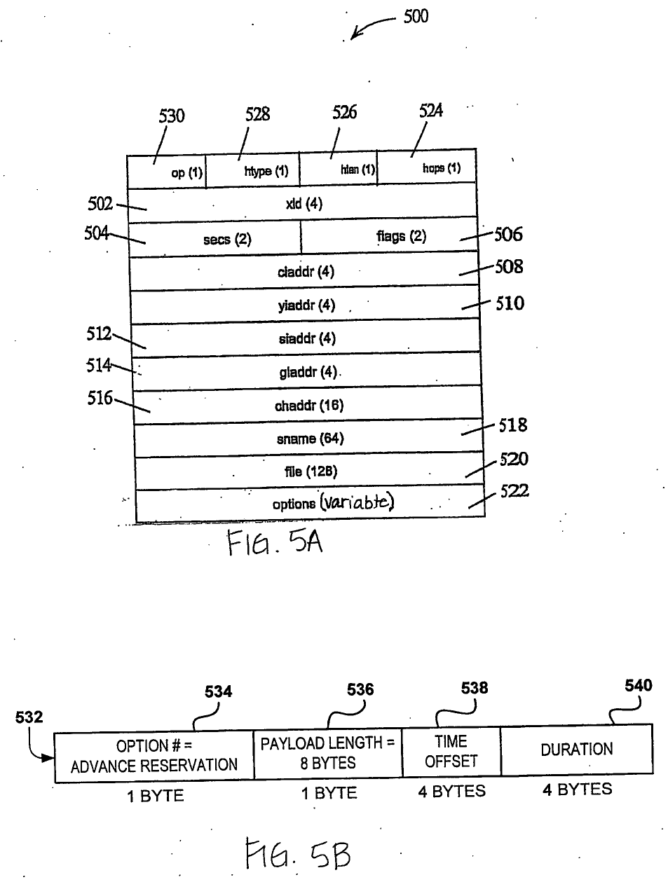

FIG. 4 illustrates a simple view of a client-server based DHCP IP Address negotiation. At boot-up or the expiration of an IP address, client 100 sends a discover packet 402 to server 102 requesting an IP address. In response, server 102 sends an offer packet 404 to client 100. Offer 404 represents an IP lease offer of a specific IP address for a limited amount of time. When client 100 receives the offer packet 404, the client sends a request packet 406 over the network to inform the server 102 that it has accepted the offer. When the server 102 receives the request packet 406 from client 100, server 102 initiates the final phase of the configuration process. This final phase involves sending an acknowledgement packet 408 to client 100. Acknowledgement 408 includes the lease duration and any other configuration that client 100 may need. At this point, the TCP/IP configuration process is complete.

FIG. 5A shows a DHCP message header 500 and its associated fields 502-530, in accordance with a preferred embodiment of the present invention. Each field in DHCP message header 500 indicates the field's name and the number of bytes shown in parenthesis. The fields shown in the DHCP message header 500 include a message opcode/message type 530, a hardware address type 528, a hardware address length 526, a hops field 524, a transaction ID 502, normally a random number chosen by the client 108, field 504, which is the amount of time passed since the client began the request process, flags 506, client IP address 508, which is the client IP address filled in by the client that knows its IP address, field 512, which is the IP address of the next server to use in the bootstrap, field 514, which is the relay agent IP address, field 516, which is a client hardware address, field 518, which is an optional server host name, field 520, which is a boot filename, and field 522, which is an optional parameters field, which can be a variable length.

An embodiment of the present invention utilizes a new option 522 called an advance reservation option 532. FIG. 5B shows the format of an advance reservation option, in accordance with a preferred embodiment of the present invention. Advance option 532 has four fields: an option number 534, a payload length 536, a time offset 538 and a duration 540. The option number 534 will be a unique number identifying the advance reservation option in DHCP, and will typically be 1 byte. The payload length 536 will typically be 1 byte and indicates the size of the payload for the advance reservation option in the DHCP header. In the example shown in FIG. 5B, the option's payload is indicated as being 8 bytes—4 bytes for each of fields 538, 540. The time offset 538 provides a relative time between the client and server by indicating the amount of time (e.g., seconds, minutes, hours, days, etc.) following receipt of the DHCP message the client is setting for the requested reservation. The use of a time offset is preferable to using a date/time stamp, as the client and server may not have synchronized time or time zones. The last field, the duration 540, indicates the lease duration for the reserved IP address being requested by the client.

Referring back to FIG. 4, the discover request 402 may include options that suggest values for the network address and an advance reservation, including a future requested lease time/date and lease duration. Upon receipt of a discover packet 402 from client 108, server 104 reads the options 522 for an advance reservation option 532, which will indicate a specified time in the future when the DHCP client 108 will require an IP address.

Server 104 will check its resources and reserve an IP address for client 108 at the future time requested in the advance reservation option field 532 (specified by time offset 538). Server 104 will then issue an offer message 404 indicating whether the advance lease was successful. This response would be in the form of an offer message 404 to client 108, specifying the reserved IP address, duration of the lease thereon, and, in a preferred embodiment, including a DHCP advance reservation option 532 specifying the time offset 538 and duration 540 of the reservation for the IP address. Thereafter, client 108 sends a request packet 406 over the network to inform the server 104 that it has accepted the offer for the advance reservation on the IP address for the future date and time. When the server 104 receives the IP request packet 406 from client 108, server 104 initiates the final phase of the configuration process. This final phase involves sending an acknowledgement packet 408 to client 108. Acknowledgement 408 also includes an advance reservation option field 532 confirming the lease future time and date, and any other configuration that client 100 may need. At this point, the TCP/IP configuration is complete. However, the leased IP address is not available to the client 108 until the reserved time.

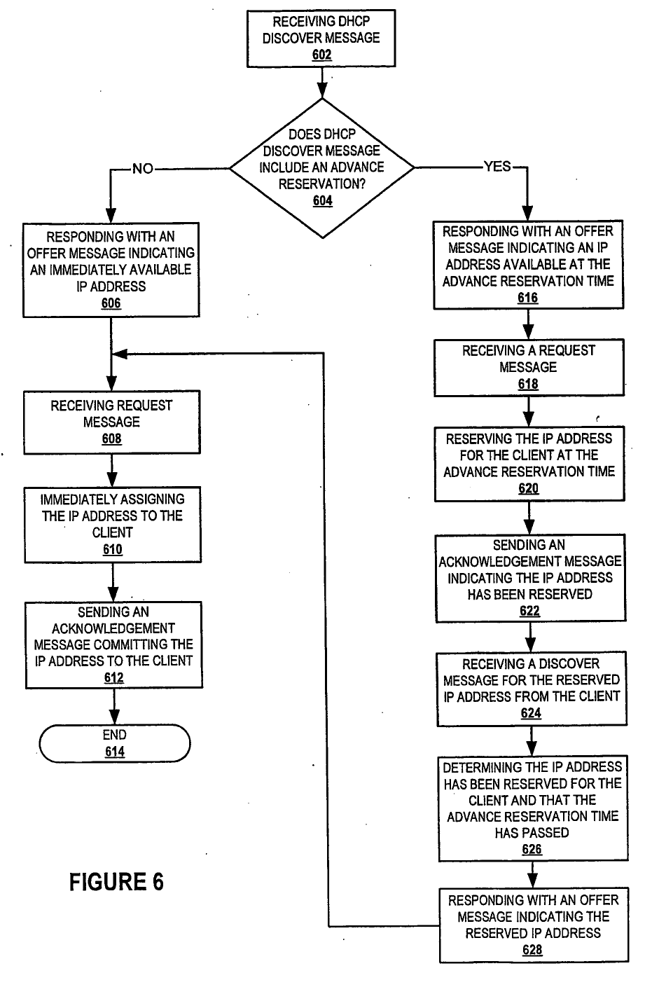

With reference now to FIG. 6, there is shown a flow diagram of a process for advance lease negotiation in DHCP, in accordance with the preferred embodiment of the present invention. The process begins when the server receives a DHCP discover message from a client (602). Upon receipt of the discover message, the server determines if the DHCP discover message includes an advance reservation option (604). If not, the server responds in accordance with DHCP by sending an offer message to the client indicating an immediately available IP address, if any (606). If acceptable to the client, the server will then receive a request message from the client (608), and will immediately assign the IP address to the client (610). The server will then send an acknowledgement message committing the IP address to the client (612), and thereafter the process will end (614).

Returning to decision block 604, if the server determines that the DHCP discover message does include an advance reservation option, the server will respond with an offer message to the client indicating an IP address that will be available, if any, at the advance reservation time indicated by the advance reservation field in the discover message (616). If the advance reservation time indicated in the offer message is acceptable to the client, the server will receive a request message for the reservation from the client (618).

The server will then reserve the IP address for the client at the advance reservation time (620). In a preferred embodiment, this is done by storing the reservation in conjunction with the reserved IP address in the database managed by the DHCP server. When determining availability of IP addresses, the server will search this database and will take into consideration any reservations for a particular IP address before committing such IP address to a client. For example, if a client is requesting an IP address for a duration that will expire before a reservation for the IP address in the database, the server is free to commit the IP address to the requesting client, since it will not create a conflict with the existing reservation. On the other hand, if a client requests an IP address for a duration that will exceed the start time of a reservation for a particular IP address, the server will be unable to offer that IP address to the client, or, alternatively, the server can offer the IP address to the client for a time duration less than requested such that the lease will expire prior to the IP addresses' reservation.

Following reservation of the IP address for the client, the server will send an acknowledgement message indicating the IP address as been reserved for the client (622). Sometime later, the client that had made the reservation will desire the reserved IP address and will issue a discover message requesting the reserved IP address. Upon receiving the discover message for the reserved IP address from the client (624), the server will determine whether the requested IP address in the discover message has been reserved for the particular client requesting the IP address, and that the advance reservation time for the requested IP address has passed (626). Normally, the reserving client will be requesting the IP address at the time of or after the client's lease on the IP address has begun, and the server will respond with an offer message indicating the reserved IP address for the client (628). If a request is received prior to the reserved time, the server may reject the request or wait until the reserved time arrives before sending an offer message. Thereafter, the standard DHCP negotiation process proceeds with the receipt of a request message (608), assignment and commitment of the IP address to the client (610), and the transmission of an acknowledgment message committing the IP address to the client (612). Thereafter, the process ends (614).

While the invention has been particularly shown and described with reference to a preferred embodiment, it will be understood by those skilled in the art that various changes in form and detail may be made therein without departing from the spirit and scope of the invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code for remote execution. A method for practicing the invention may result from combining one or more machine-readable storage devices containing the code with appropriate standard computer hardware to execute the code. An apparatus for practicing the invention could be one or more computers and storage systems containing or having network access to computer program(s) coded in accordance with the invention.

What is claimed is:

1. A method for lease negotiation in DHCP in a data processing network comprising:
receiving a reservation request from a client to be assigned an IP address at a specific time in the future;
reserving a specific IP address for the client to be assigned at the specific time requested; and
assigning the specific IP address to the client after the specified time in response to receiving an assignment request from the client for the reserved IP address.

2. The method according to claim 1, wherein the reservation request is a DHCP-DISCOVER message having an advance reservation option indicating the specified time.

3. The method according to claim 1, wherein the assignment request is a DHCP-DISCOVER message indicating the reserved IP address.

4. The method according to claim 1, further comprising sending a DHCP-OFFER message having an advance reservation option indicating the specified time in response to the reservation request, prior to reserving the specific IP address.

5. The method according to claim 1, further comprising sending a DHCP-ACKNOWLEDGE message having an advance reservation option indicating the specified time, after reserving the specific IP address, wherein the specific IP address is made available to a client receiving the DHCP-ACKNOWLEDGE message after the specified time.

6. The method according to claim 6, wherein the step of assigning includes only assigning the specific IP address to a client receiving the DHCP-ACKNOWLEDGE message.

7. The method according to claim 1, wherein the assignment request is received before the specified time.

8. The method according to claim 1, wherein the reservation request from the client includes a request to be assigned the IP address for a specific duration of time.

9. A data processing system for lease negotiation in DHCP comprising:
means for receiving a reservation request from a client to be assigned an IP address at a specific time in the future;
means for reserving a specific IP address for the client to be assigned at the specific time requested; and
means for assigning the specific IP address to the client after the specified time in response to receiving an assignment request from the client for the reserved IP address.

10. The system according to claim 9, wherein the reservation request is a DHCP-DISCOVER message having an advance reservation option indicating the specified time.

11. The system according to claim 9, wherein the assignment request is a DHCP-DISCOVER message indicating the reserved IP address.

12. The system according to claim 9, further comprising means for sending a DHCP-OFFER message having an advance reservation option indicating the specified time in response to the reservation request, prior to reserving the specific IP address.

13. The system according to claim 9, further comprising means for sending a DHCP-ACKNOWLEDGE message having an advance reservation option indicating the specified time, after reserving the specific IP address, wherein the specific IP address is made available to a client receiving the DHCP-ACKNOWLEDGE message after the specified time.

14. The system according to claim 13, wherein the means for assigning includes only assigning the specific IP address to a client receiving the DHCP-ACKNOWLEDGE message.

15. The system according to claim 9, wherein the assignment request is received before the specified time.

16. The system according to claim 9, wherein the reservation request from the client includes a request to be assigned the IP address for a specific duration of time.

17. An article of manufacture comprising machine-readable medium including program logic embedded therein for lease negotiation in DHCP that causes control circuitry in a data processing system to perform the steps of:
receiving a reservation request from a client to be assigned an IP address at a specific time in the future;
reserving a specific IP address for the client to be assigned at the specific time requested; and
assigning the specific IP address to the client after the specified time in response to receiving an assignment request from the client for the reserved IP address.

18. The article of manufacture according to claim 17, wherein the reservation request is a DHCP-DISCOVER message having an advance reservation option indicating the specified time.

19. The article of manufacture according to claim 17, wherein the assignment request is a DHCP-DISCOVER message indicating the reserved IP address.

20. The article of manufacture according to claim 17, further comprising sending a DHCP-OFFER message having an advance reservation option indicating the specified time in response to the reservation request, prior to reserving the specific IP address.

21. The article of manufacture according to claim 17, further comprising sending a DHCP-ACKNOWLEDGE message having an advance reservation option indicating the specified time, after reserving the specific IP address, wherein the specific IP address is made available to a client receiving the DHCP-ACKNOWLEDGE message after the specified time.

22. The article of manufacture according to claim 21, wherein the step of assigning includes only assigning the specific IP address to a client receiving the DHCP-ACKNOWLEDGE message.

23. The article of manufacture according to claim 17, wherein the assignment request is received before the specified time.

24. The article of manufacture according to claim 17, wherein the reservation request from the client includes a request to be assigned the IP address for a specific duration of time.
